(19) United States
(12) Patent Application Publication
(10) Pub. No.: US 2009/0275251 A1
(43) Pub. Date: Nov. 5, 2009

(54) FLEXIBLE FILM BASED ON FLUORINATED POLYMER

(75) Inventors: Anthony Bonnet, Beaumont Le Roger (FR); Sandrine Duc, Istres (FR); Cyrille Mathieu, Rouen (FR); Johann Laffargue, Bernay (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France`, Colombes (FR)

(21) Appl. No.: 12/162,144

(22) PCT Filed: Jan. 25, 2007
(86) PCT No.: PCT/FR2007/050693

§ 371 Date: Oct. 30, 2008

(30) Foreign Application Priority Data
Jan. 25, 2006 (FR) 0600695

(51) Int. Cl. B32B 27/12; B32B 27/06; B32B 27/08; B32B 27/38; C08L 27/12

(52) U.S. Cl. 442/133; 428/422; 428/421; 428/413; 525/199

(57) ABSTRACT

The invention concerns a multilayer structure comprising: a PVDF-based film F1 affixed to a PET or PEN sheet; or a PVDF-based film F1 bonded to a PET or PEN sheet which is itself affixed to a PVDF-based film F2. The F1 and/or F2 films comprising (starting from the PET or PEN sheet): optionally a layer of composition B comprising 5 to 40 parts of at least one PVDF, 60 to 95 parts of at least one PMMA and 0 to 5 parts of at least one UV absorber, the total making 100 parts; a layer of composition A, comprising 50 to 100 parts of at least one PVDF, 0 to 50 parts of at least one PMMA, 0 to 30 parts of at least one mineral filler and 0 to 3 parts of at least one dispersant, the total making 100 parts; optionally a layer of composition C comprising 80 to 100 parts of at least one PVDF, 0 to 20 parts of at least one PMMA, 0 to 30 parts of at least one mineral filler and 0 to 3 parts of at least one dispersant, the total making 100 parts; such that an adhesive layer is interposed between the PET or PEN sheet and the F1 and/or F2 films; said adhesive layer being optional if the layer of composition B is present and not including any polyolefin functionalized by an unsaturated carboxylic acid or anhydride, or a homo- or copolymer including as monomer(s) acrylic acid, acrylates and alkyl acrylates optionally modified by an unsaturated acid or anhydride; such that the compositions A and/or B do not contain any acrylic elastomer particle nor any core-coat particle.

### FIELD OF THE INVENTION

The present invention relates to a PVDF-based film for protecting substrates and to the substrates covered with this film. It also relates to a multilayer structure combining a PET or PEN sheet with the PVDF-based film. Finally, the invention relates to the uses of the PVDF-based film or of the multilayer film, especially for the protection of photovoltaic modules.

1. Technical Problem

PVDF (polyvinylidene fluoride), because of its very good weatherability and resistance to radiation and chemicals, is a polymer useful for protecting objects and materials. It is also appreciated for its shiny appearance and its graffiti resistance. It is therefore common practice to coat all kinds of objects with a PVDF film. However, the film must have good adhesion to the substrate to be protected and exhibit very good thermal resistance as required in external applications exposed to severe weather conditions or to conversion processes carried out at high temperature. It is also necessary for the film to exhibit good flexibility and a high strength so as to withstand mechanical stresses that arise when the film is being placed over the object, or once the film has been placed on the object when the latter is formed, for example by drawing. One applicative test used consists in tearing a film that has undergone oven ageing and in seeing whether the tear propagates easily or not.

The Applicant has developed a PVDF-based film which exhibits good flexibility, has a high strength and can be used in certain applications. It has also developed a multilayer structure by combining the PVDF-based film with a PET or PEN sheet.

2. Prior Art

Application EP 1 382 640 describes a film consisting of two or three layers based on a PVDF homopolymer or copolymer. The PVDF copolymer contains 0 to 50% comonomer. The examples describe the use of PVDF homopolymer.

Application EP 1 566 408 describes a film consisting of two or three layers based on PVDF homopolymer or copolymer. The PVDF copolymer contains 0 to 50%, advantageously 0 to 25% and preferably 0 to 15% comonomer. The film contains no filler.

Application EP 172 864 describes a photovoltaic cell protected by a PVDF/PET film. There is no adhesive layer between the PVDF and the PET.

International Application wo 2005/081859 describes multilayer films based on fluoropolymer and acrylic polymer.

U.S. Pat. No. 6,555,190 describes a multilayer structure comprising, in order, a PEN layer, an adhesive layer and a layer of a fluoropolymer (PCTFE, PVDF, etc.). The adhesive layer comprises a polyolefin functionalized by an unsaturated carboxylic acid or anhydride, or else a homopolymer or copolymer comprising, as monomer(s) acrylic acid, acrylates and alkyl acrylates, which is optionally modified by an unsaturated acid or anhydride.

Application US 2005/0268961 describes a photovoltaic module protected by a film comprising two fluoropolymer layers, one having a melting point above 135° C. and the other having a melting point below 135° C.

Application US 2005/0172997 or U.S. Pat. No. 6,369,316 describe a photovoltaic module protected by a polyvinylidine (TEDLAR) film.

### FIGURES

FIG. 1 shows an assembly 1 comprising a photovoltaic module 2 protected by 3.

FIG. 2 shows schematically an assembly 4 comprising a photovoltaic module 2 protected by the film 3. The module 2 comprises a layer 6 consisting of photovoltaic cells encapsulated in a thermoplastic resin (e.g. EVA). The module 2 also comprises a glass plate 5 serving as front support for the module 2. The protection is provided by a multilayer structure 3 comprising a PET sheet 8 placed between two PVDF-based films, references 7 and 7′.

FIG. 3 shows a deep-drawn part 9 (in the schematic form of a cup) made of a steel sheet 10 protected by a PVDF-based film, reference 11.

### BRIEF DESCRIPTION OF THE INVENTION

The invention relates to a multilayer structure using a PVDF-based film as defined in claim 1.

The invention also relates to the uses of said structure and to the process for manufacturing a PVDF-based film.

### DETAILED DESCRIPTION

The term “PVDF” denotes PVDF polymers, namely vinylidene fluoride (VDF, or CH₂═CF₂) homopolymers and VDF copolymers preferably containing 50% VDF by weight and at least one other fluoromonomer copolymerizable with VDF. Preferably, the PVDF contains, by weight, at least 50%, more preferably at least 75% and better still at least 85% VDF.

Preferably, to increase the flexibility of the film, it is possible to use, for any one of the layers of the film, a PVDF advantageously comprising, by weight, 5 to 20%, advantageously 7 to 13% of at least one fluorinated comonomer per 80 to 95% and advantageously 87 to 93% VDF (this type of PVDF will be referred to hereafter as “flexible PVDF”). Preferably flexible PVDF is used for compositions A and B.

Advantageously, the fluorinated comonomer copolymerizable with VDF is chosen from: vinyl fluoride; trifluoroethylene (VF3); chlorotrifluoroethylene (CTFE); 1,2-difluoroethylene; tetrafluoroethylene (TFE); hexafluoropropylene (HFP); perfluoro(alkyl vinyl)ethers, such as perfluoro(methyl vinyl)ether (PMVE), perfluoro(ethyl vinyl)ether (PEVE) and perfluoro(propyl vinyl)ether (PPVE); perfluoro(1,3-dioxole); and perfluoro(2,2-dimethyl-1,3-dioxole) (PDD).

Preferably, the fluorinated comonomer is chosen from chlorotrifluoroethylene (CTFE); hexafluoropropylene (HFP), trifluoroethylene (VF3); and tetrafluoroethylene (TFE).

Advantageously, the comonomer is HFP as this copolymerizes well with VDF and makes it possible to achieve good thermomechanical properties. Preferably, the copolymer comprises only VDF and HFP.

Advantageously, the PVDF has a viscosity ranging from 100 Pa·s to 2000 Pa·s, the viscosity being measured by a capillary rheometer at 230° C. and at a shear rate of 100 s⁻¹. This type of PVDF is well-suited to extrusion. Preferably, the PVDF has a viscosity ranging from 300 Pa·s to 1200 Pa·s, the viscosity being measured using a capillary rheometer at 230° C. and at a shear rate of 100 s⁻¹.

The term “PMMA” denotes methyl methacrylate (MMA) homopolymers and copolymers containing at least 50% MMA by weight and at least one other monomer copolymerizable with MMA.

As examples of comonomers copolymerizable with MMA, mention may be made of alkyl(meth)acrylates, acrylonitile, butadiene, styrene and isoprene. Examples of alkyl (meth)acrylates are described in KIRK-OTHMER^{X}, Encyclopedia of Chemical Technology, 4th edition in vol. 1, pages 292-293 and in vol. 16, pages 475-478.

Advantageously, the PMMA contains, by weight, 0 to 20% and preferably 5 to 15% of a C₁-C₈ alkyl(meth)acrylate, which is preferably methyl acrylate and/or ethyl acrylate. The PMMA may be functionalized, that is to say it contains for example acid, acid chloride, alcohol or anhydride functional groups. These functional groups may be introduced by grafting or by copolymerization. Advantageously, this is an acid functional group provided by the acrylic acid comonomer. Two adjacent acrylic acid functional groups may lose water to form an anhydride. The proportion of functional groups may be from 0 to 15% by weight of the PMMA including the possible functional groups.

The PMMA may comprise at least one acrylic elastomer but it is preferable to avoid using such a PMMA since the acrylic elastomer can cause whitening of the film. Commercially available are PMMA grades that are called “impact” PMMA grades, these containing an acrylic elastomer in the form of multilayer particles. The acrylic elastomer is then present in the PMMA as sold (that is to say introduced into the resin during the manufacturing process, but it may also be added during manufacture of the film. The proportion of acrylic elastomer varies from 0 to 30 parts per 70 to 100 parts of PMMA, the total making 100 parts. The multilayer particles, also commonly called core-shell particles, can be used as acrylic elastomer. They comprise at least one elastomer (or soft) layer, that is to say a layer formed from a polymer having a glass transition temperature (T_{g}) below −5° C., and at least one rigid (or hard) layer, that is to say formed from a polymer having a T_{g} above 25° C. The size of the particles is generally less than 1 μm and advantageously between 50 and 300 nm. Examples of multilayer particles of the core-shell type may be found in the following documents: EP 1 061 100 A1, US 2004/0030046 A1, FR-A-2 446 296 and US 2005/0124761 A1. Particles having at least 80% soft elastomeric phase by weight will be preferred. The function of the acrylic elastomer is to improve the tensile strength of the PMMA (impact modifier) and to promote flexibility of the PMMA.

The MVI (melt volume index) of the PMMA may be between 2 and 15 cm³/10 min measured at 230° C. and under a load of 3.8 kg.

With regard to the adhesive layer, this allows the film to adhere to the substrate and consists of any type of adhesive allowing the film to adhere to the substrate. Urethane (PU), epoxy, acrylic or polyester adhesives may be used for the adhesive layer, these being either in thermoplastic form or thermosetting form. Advantageously, a PU adhesive may be used.

With regard to the UV absorber, this may for example be the additives mentioned in U.S. Pat. No. 5,256,472. Advantageously, compounds of the benzotriazole, benzophenone, benzylidene malonate or quinazoline type are used. For example, TINUVIN® 213 or TINUVIN® 109, and preferably TINUVIN® 234, from Ciba Specialty Chemicals may be used.

With regard to the dispersing agent, this has the function of helping to disperse the mineral filler. It is preferably a polyalkylene glycol, i.e. a polymer containing alkylene oxide (for example ethylene oxide or propylene oxide) units. Preferably, it is poly(oxyethylene) glycol, usually called polyethylene glycol (PEG). The polyalkylene glycol preferably has a number-average molecular weight of between 1000 and 10 000 g/mol. The polyalkylene glycol allows the particles of the mineral filler to be coated and prevents them from coming into direct contact with the PVDF.

Examples of PEG are described in the U.S. Pat. Nos. 5,587,429 and U.S. 5,015,693. Thus, mention may be made of: polyethylene glycol of formula H(OC₂H₄)ₙOH where n is an integer close to 76, being between 70 and 80; the product of formula H(OC₂H₄)_{D}[OCH(CH₃)CH₂]ₑ(OC₂H₄)_{f}OH where d, e and f denote integers with d+f close to 108, being between 100 and 110, and e close to 35, being between 30 and 40; CARBOWAX® 3350 having a number-average molecular weight of about 3500 g/mol; CARBOWAX® 8000 having a number-average molecular weight of about 8000 g/mol; and POLYGLYCOL® 8000 from Clariant having a number-average molecular weight of between 7000 and 9000 g/mol.

With regard to the mineral filler, this may be a metal oxide such as, for example, titanium dioxide (TiO₂), silica, quartz, alumina, a carbonate, such as for example calcium carbonate, talc, mica, dolomite (CaCO₃.MgCO₃), montmorillonite (aluminosilicate), BaSO₄, ZrSiO₄, Fe₃O₄.

The mineral filler acts as an opacifier in the UV/visible range. The protective action of the filler is complementary to that of the UV absorber. In addition, unlike the UV absorber which is an organic molecule, the opacifying mineral filler retains a protective action for a longer time (it is not degraded). A TiO₂ filler is most particularly preferred from this standpoint.

The mineral filler may also have another function. For example, it may be a fire retardant such as, for example, antimony oxide (Sb₂O₃, Sb₂O₅), Al(OH)₃, Mg(OH)₂, huntite (3MgCO₃.CaCO₃), hydromagnesite (3MgCO₃Mg(OH)₂.3H₂O). It may also be an electrically conductive filler (for example, carbon black or carbon nanotubes).

The filler has a size generally between 0.05 μm and 1 mm. Preferably, the mineral filler content in composition A or C is between 0.1 and 30 parts (for a total of 100 parts). Advantageously, the content varies between 10 and 25 parts and preferably between 10 and 20 parts. It is preferable for the mineral filler content to be at least 10 parts in order to observe good efficiency of the opacifying (and possibly fire-retarding) filler. It is also preferable for this content not to exceed 25 parts, or even 20 parts, so as not to degrade the mechanical properties of the layer containing the filler, and therefore the mechanical properties of the entire film.

With regard to the PVDF-based film, this is in various forms.

### 1st Form

In a 1st form, the PVDF-based film comprises 50 to 100 parts of at least one PVDF, 0 to 50 parts of at least one PMMA, 0 to 30 parts of at least one mineral filler and 0 to 3 parts of at least one dispersing agent, the total making 100 parts (composition A). The film adheres to the substrate by means of an adhesive layer, which may for example be a layer of a polyurethane (PU) adhesive. This therefore gives a multilayer structure comprising, in the following order:
substrate/adhesive layer/layer of composition A.

### Best Mode

Composition A comprises 50 to 70 parts of at least one PVDF, 10 to 40 parts of at least one PMMA and 10 to 25 parts of at least one mineral filler (prefereably TiO₂), the total making 100 parts. Example: 60% flexible PVDF+15% TiO₂+25% PMMA (see Example 1).

Preferably, the PVDF of composition A is a flexible PVDF.

### 2nd Form

In a 2nd form, the PVDF-based film comprises a layer of composition A and a layer of composition B comprising 5 to 40 parts of at least one PVDF, 60 to 95 parts of at least one PMMA and 0 to 5 parts of at least one UV absorber, the total making 100 parts. The film adheres to the substrate either by means of composition B or by means of an adhesive layer placed between the substrate and the layer of composition B. This therefore gives a multilayer structure comprising, in the following order:
substrate/possible adhesive layer/layer of composition B/layer of composition A.

Preferably, the PVDF of composition B is a flexible PVDF. Preferably, composition B contains no acrylic elastomer and no core-shell particle.

### 3rd Form

In a 3rd form, the PVDF-based film comprises a layer of composition C comprising 80 to 100 parts of at least one PVDF, 0 to 20 parts of at least one PMMA, 0 to 30 parts of at least one mineral filler and 0 to 3 parts of at least one dispersing agent, the total making 100 parts, and a layer of composition A. The film adheres to the substrate by means of an adhesive layer. This therefore gives a multilayer structure comprising, in the following order:
substrate/adhesive layer/layer of composition A/layer of composition C.

### Best Mode

Composition C comprises, as polymer, only PVDF. Composition

A comprises 50 to 70 parts of at least one PVDF, 10 to 40 parts of at least one PMMA and 10 to 25 parts of at least one mineral filler (preferably TiO₂), the total making 100 parts. Example: [60% flexible PVDF+15% TiO₂+25% PMMA]/PVDF homopolymer (see Example 3).

Preferably, the PVDF of composition C is a PVDF homopolymer. Preferably, the PVDF of composition A is a flexible PVDF.

### 4th Form

In a 4th form, the PVDF-based film comprises a layer of composition C, a layer of composition A and a layer of composition B. The film adheres to the substrate either by means of composition B or by means of an adhesive layer. This therefore gives a multilayer structure comprising, in the following order:
substrate/possible adhesive layer/layer of composition B/layer of composition A/layer of composition C.

### Best Mode

Composition C comprises, as polymer, only PVDF. Composition B comprises 5 to 40 parts of at least one PVDF, 60 to 95 parts of at least one PMMA and 0 to 5 parts of at least one UV absorber, the total making 100 parts. Composition A comprises 50 to 70 parts of at least one PVDF, 10 to 40 parts of at least one PMMA and 10 to 25 parts of at least one mineral filler (preferably TiO₂), the total making 100 parts.

Preferably, the PVDF of composition C is a PVDF homopolymer. Preferably, the PVDF of composition A and/or B is a flexible PVDF.

In the 3rd and 4th forms, the layer of composition C, which is placed against the layer of composition A, is therefore the “outermost” layer. For all the forms, composition A and/or B preferably contains no acrylic elastomer nor any core-shell particle. This may cause whitening of the film when the latter is subjected to a large deformation, which is the case, for example, during the manufacture of the film either when placing the film on the substrate (for example when drawing a metal foil protected by the film).

The PVDF-based film that protects the substrate therefore comprises, in the following order, starting from the substrate: a possible layer of composition B; a layer of composition A; and a possible layer of composition C, the film adhering to the substrate via an adhesive layer and, if the layer of composition B is present, the adhesive layer is optional. For each of the forms of the invention, the thickness of the layer of composition A is preferably between 5 and 50 μm, preferably between 5 and 15 μm. The thickness of the layer of composition B is preferably between 5 and 45 μm, preferably between 5 and 15 μm. The thickness of the layer of composition C is preferably between 2 and 30 μm, preferably between 2 and 15 μm.

Manufacture of the PVDF-Based films

The PVDF-based film is preferably manufactured by the technique of coextrusion, but it is also possible to use a solvent processing technique or else to use a coating technique.

The PVDF-based film may also be manufactured by blown film coextrusion. This technique consists in extruding, generally upwards, a thermoplastic polymer through an annular die, simultaneously the extrudate is pulled longitudinally by a pulling device, usually consisting of rolls, and inflated with a constant volume of air trapped between the die, the pulling system and the wall of the tube. The inflated tube, also called the “bubble”, is generally cooled by an air blowing ring at the die exit. The flattened bubble is wound up either in the form of a tube or, after slitting, as two separate films. In EP 0 278 804 A1, a semicrystalline fluid polymer is coextruded with a thermoplastic resin that is incompatible, in such a way that, after the bubble has been cooled and flattened, the two extruded films are recovered separately by conventional means, such as by winding the separate films separately. In the single example, the bubble consists of a 25 μm film of PVDF coextruded with a 60 μm film of polyethylene (PE). In the description, it is stated that the thickness of the PE film must preferably be 1 to 5 times the thickness of the semicrystalline polymer film. It is also stated that it is not excluded to be able to coextrude more than two films, although nothing is mentioned about the precise nature of the films in question. International Application WO 03/039840 describes a process for manufacturing a fluorinated film that also uses an incompatible polymer, which may be a PE, an impact polystyrene or a plasticized PVC, preferably a low-density PE.

The process for manufacturing the PVDF-based film by the technique of blown film coextrusion consists in coextruding:
a) the various layers of the PVDF-based film of compositions A, B, C);
b) a layer L1 of a polyolefin adjacent layer of composition A or the layer of composition C; and
c) possibly, another layer L2 of a polyolefin adjacent the combination of the layers extruded at a) and b), on the side opposite the layer extruded at b),
   and, after cooling the coextrudate, in recovering the PVDF-based film by separating it from the polyolefin layer(s).

The polyolefin (also called the “liner”) used at b) may be the same as or different from that used at c).

### [Uses of the Film]

The uses of the PVDF-based film will now be described in greater detail.

### Use as Protective Film for Photovoltaic Modules

Photovoltaic modules may be protected at the rear by the PVDF-based film. A photovoltaic module converts light energy into electrical current. In general, a photovoltaic module comprises photovoltaic cells mounted in series and connected together by electrical connection means. The photovoltaic cells are generally mono-junction cells manufactured from polycrystalline silicon p-doped with boron during fusion of the silicon and n-doped with phosphorus on their illuminated surfaces. These cells are placed in a laminated stack. The laminated stack may consist of EVA (ethylene/vinyl acetate copolymer) covering the photovoltaic cells in order to protect the silicon from oxidation and moisture. The stack is embrocated between a glass plate, which serves as support on one side, and a film on the other side, for protecting it. The photovoltaic module is thus protected from ageing (UV, salt fog, etc.), scratches, moisture or water vapor.

The module is generally protected by a multilayer structure sold under the brand AKASOL® or ICOSOLAR®, which is a combination of a TEDLAR® (polyvinyl fluoride or PVDF) film and a PET (polyethylene terephthalate) sheet. The Applicant has found that a PVDF-based film, as defined above, may advantageously be used instead of the TEDLAR® film. One advantage is in particular that PVDF has a better mechanical strength and a higher melting point (higher thermal resistance) than PVF. The multilayer structure therefore comprises a PET sheet bonded to at least one PVDF-based film as defined above and is:
in the form of a PVDF-based film F1/PET sheet; or
in the form of a PVDF-based film F1/PET sheet/PVDF-based film F2.

In this 2nd form, the two films F1 and F2 are as defined above. They may be identical or different, that is to say they may take, independently of each other, one of the four forms of the invention described above. Each of the two films F1 or F2 adheres to the PET sheet by means of a layer of composition B or else by means of an adhesive layer.

The multilayer structure comprises:
a PVDF-based film F1 bonded to a PET or PEN sheet; or
a PVDF-based film F1 bonded to a PET or PEN sheet which is itself bonded to a PVDF-based film F2, the film F1 and/or F2 comprising (in the order starting from the PET or PEN sheet):
possibly, a layer of composition B comprising 5 to 40 parts of at least one PVDF, 60 to 95 parts of at least one PMMA and 0 to 5 parts of at least one UV absorber, the total making 100 parts;
a layer of composition A, comprising 50 to 100 parts of at least one PVDF, 0 to 50 parts of at least one PMMA, 0 to 30 parts of at least one mineral filler and 0 to 3 parts of at least one dispersing agent, the total making 100 parts; and
possibly, a layer of composition C comprising 80 to 100 parts of at least one PVDF, 0 to 20 parts of at least one PMMA, 0 to 30 parts of at least one mineral filler and 0 to 3 parts of at least one dispersing agent, the total making 100 parts; such:
that an adhesive layer is placed between the PET or PEN sheet and the film F1 and/or F2;
this adhesive layer being optional if the layer of composition B is present.

Preferably, the adhesive layer contains no polyolefin functionalized by an unsaturated carboxylic acid or anhydride, or else a homopolymer or copolymer comprising, as monomer(s), acrylic acid, alkyl acrylates and acrylates, which is optionally modified by an unsaturated acid or anhydride. Also preferably, compositions A and/or B contain no acrylic elastomer nor any core-shell particle.

The structure therefore comprises, in the following order of succession:
poss. comp. C/comp. A/poss. comp. B/adhesive layer/PET; or
poss. comp. C/comp. A/poss. comp. B/adhesive layer/PET/adhesive layer/poss. comp. B/comp. A/poss. comp. C.

The adhesive layer is optional if the layer of composition B is present. If an adhesive layer is used, a PU adhesive is preferred.

The multilayer structure may be manufactured by hot-pressing the various elements (that is to say the PET sheet, the PVDF-based film(s), etc.). It is also possible to use a lamination technique, which consists in continuously laminating the PVDF-based film(s) (previously in roll form) to the PET sheet on which the adhesive has possibly been deposited. An example of a vacuum lamination process for applying an AKASOL® or ICOSOLAR®-type structure to a photovoltaic module is described in U.S. Pat. No. 5,593,532 and may be applied to the multilayer structure of the invention. In general, the structure is therefore manufactured by combining the PVDF-based film(s) already formed with the PET sheet. This is why it is preferred to use an adhesive, which is deposited in the liquid state, of the thermosetting type rather than a thermoplastic, which requires recourse to coextrusion. This is why it is excluded for the adhesive layer to contain a polyolefin functionalized by an unsaturated carboxylic acid or anhydride, or else a homopolymer or copolymer comprising, as monomer(s), acrylic acid, alkyl acrylates and acrylates, which is optionally modified by an unsaturated acid or anhydride.

Instead of PET, it is also possible to use PEN (polyethylene naphthalate) which has the advantage of a higher T_{g} than PET. PEN possesses excellent UV resistance, but PEN films are brittle and do not form a moisture barrier.

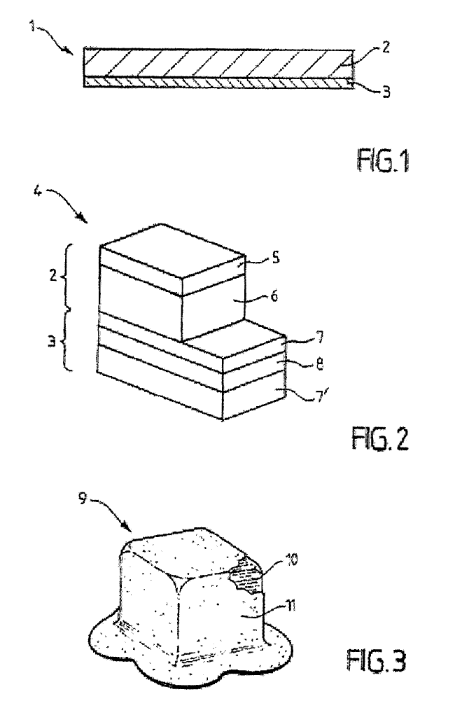

FIGS. 1 and 2 show schematically examples of a protective photovoltaic module 2. The reference 3 in FIG. 1 represents either a PVDF-based film or a multilayer structure in which a PET or PEN sheet is combined with one or two PVDF-based films.

The invention also relates to a photovoltaic module protected by the PVDF-based film or by the multilayer structure. In the case of the PVDF-based film, the assembly therefore comprises, in the following order: (module)/adhesive layer/poss. comp. B/comp. A/poss. comp. C,

the adhesive layer being optional if the layer of composition B is present. In the case of the multilayer structure, the assembly comprises in the following order:
(module)/poss. comp. C/comp. A/poss. comp. B/adhesive layer/PET or:
(module)/poss. comp. C/comp. A/poss. comp. B/adhesive layer/PET/adhesive layer/poss. comp. B/comp. A/poss. comp. C,
   the adhesive layer being optional if the layer of composition B is present.

The invention is not however limited to the photovoltaic module as described above or in FIG. 2. Thus, other examples of photovoltaic modules will be found in FR 2 863 775 A1 (see especially FIG. 1), U.S. Pat. No. 6,369,316 BE, US 2004/0229394 A1, US 2005/0172997 A1 and US 2005/0268961 A1.

### Use as Protective Film for Flexible Substrates

The PVDF-based film may be used to protect a flexible substrate, such as for example a technical textile which can be woven or non-woven. It can be a fabric made of PVC, of polyester or of polyamide, a glass fabric, a glass mat, an aramid or Kevlar fabric, etc.). A PVC tarpaulin constitutes an example of a PVC flexible substrate. The PVDF-based film may be applied onto the technical fabric for example using a lamination technique or by coating.

The invention also relates to a technical textile protected by the PVDF-based film. The assembly therefore comprises, in the following order: (technical textile)/adhesive layer/poss. comp. B/comp. A/poss. comp. C, the adhesive layer being optional if the layer of composition B is present.

### Use as Protective Film for a Metal Sheet

The PVDF-based film may be colaminated onto a metal substrate, which may, for example be made of steel, copper or aluminum. Preferably, the substrate is a metal sheet, preferably a steel sheet. Preferably, the steel is galvanized and may or may not be coated with a primer. The steel may for example be treated with Zincrox or coated with the acrylic/vinyl primer B1236, the epoxy primer B710 or the polyester melamine primer CN4118. The PVDF-based film is sufficiently flexible for the steel/film assembly to then be capable of undergoing a large deformation. For example, the assembly may be deep-drawn.

FIG. 3 shows an example of a steel component 10 protected with the PVDF-based film, reference 10. The component represents a metal cup (for example a steel cup) obtained by deep-drawing a metal sheet onto which the film has been colaminated.

The invention also relates to the metal substrate protected by the PVDF-based film. The assembly therefore comprises, in the following order: (metal)/poss. primer/adhesive layer/poss. comp. B/comp. A/poss. comp. C, the adhesive layer being optional if the layer of composition B is present.

### EXAMPLES

### Products Used

PVDF-1: a VDFR/HFP copolymer in granule form (10% HFP by weight) having an MVI of 1.1 cm³/10 min (230° C./5 kg), a viscosity of 2500 mPa·s at 230° C./100 s⁻¹ and a melting point of about 145° C.

ALTUGLAS® BS 580 (previously sold under the name OROGLAS® BS8): A PMMA from Altuglas International (previously Atoglas) having an MVI of 4.5 cm³/10 min (230° C./3.8 kg) in bead form, containing a comonomer, namely 6% methyl acrylate by weight. This PMMA contains no impact modifier nor any acrylic elastomer.

PVDF-2: a PVDF homopolymer in granule form having an MVI of 1.1 cm³/10 min (230° C./5 kg).

PVDF-3: A VDF/HFP copolymer in granule form (17% HFP by weight) having an MVI of 10 cm³/10 min (230°/5 kg) and a viscosity of 900 mPa·s at 230° C./100 s⁻¹.

DESMODUR® N-100: an aliphatic isocyanate of CAS No. 28182-81-2 sold by Lanxess.

FLUORAD® FC-430, a fluorosurfactant from 3M.

TONE® 201: a poly(caprolactone) diol sold by Union Carbide (molecular weight about 830 g/mol).

### Example 1

### According to the Invention, 1st Form

[60% flexible PDVF+15% TiO₂+25% PMMA]_{layer A}/PET/PU adhesive

A monolayer film consisting by weight of 60% PVDF-1, 15% R960 TiO₂ and 25% ALTUGLAS® BS 580 was extruded in the form of a film 15 μm in thickness and 2000 mm in width using a film extruder at a temperature of 245° C.

A polyester (PET) substrate, onto which an adhesive of the urethane family, obtained by reacting 100 parts of TONE® 201 with 0.5 parts of a 1% DBTL (dibutyl ter dilaurate) solution in xylol, 60 parts of propylene glycol methyl ether acetate, 0.6 part of 10% FC-430 (a fluorosurfactant) and 74 parts of DESMODUR N-100, had been deposited beforehand was held in an oven at 120° C. for 5 minutes. The monolayer film was then laminated at 130° C. onto the polyester substrate (therefore giving a PET/PU adhesive/monolayer film structure). The adhesive strength obtained was greater than 40 N/cm. After 8 hours in an oven at 95° C., the adhesion was maintained, and the structure could be easily folded without thereby generating cracks within the fluorinated film.

### Example 2

### According to the Invention, 3rd form)

[PVDF homopolymer]_{layer C}/[60% flexible PVDF+15% TiO₂+25% PMMA]_{layer A}/PET/PU adhesive

A two-layer film, consisting of:
a 15 μm thick layer containing, by weight, 60% PVDF-1, 15% R960TiO₂ and 25% ALTUGLAS® BS 580 PMMA; and
a 10 μm thick layer containing 100% PVDF-2 and having a width of 2000 mm was produced in a film extruder at a temperature of 245° C.

A polyester (PET) substrate onto which an adhesive of the urethane family, obtained by reacting 100 parts of TONE® 201 with 0.5 parts of a 1% DBTL (dibutyl ter dilaurate) solution in xylol, 60 parts of propylene glycol methyl ether acetate, 0.6 part of 10 wt % FC-430 (a fluorosurfactant) and 74 parts of DESMODUR N-100, had been deposited beforehand was placed in an oven at 120° C. for 5 minutes. The bilayer film was then laminated at 150° C. onto the polyester substrate (therefore giving a PET/PU adhesive/PVDF-1-containing layer/PVDF-2-containing layer structure).

The adhesive strength obtained was greater than 60 N/cm. After 8 hours in an oven at 95° C., the adhesion was maintained and the structure could be easily folded without thereby generating cracks in the fluorinated film.

### Example 3

### According to the Invention, 1st Form

[83% flexible PVDF+15% Sb₂O₃+2% PEG]_{layer A}/PET/PU Adhesive

A monolayer film consisting, by weight, of 83% PVDF-3, 15% Sb₂O₃ and 2% of a PEG of 1500 g/mol molecular weight from Clariant was extruded in the form of a film 15 μm in thickness and 2000 mm in width using a film extruder at a temperature of 245° C.

A polyester (PET) substrate, onto which an adhesive of the urethane family, obtained by reacting 100 parts of TONE® 201 with 0.5 part of a 1% DBTL (dibutyl ter dilaurate) solution in xylol, 60 parts of propylene glycol methyl ether acetate, 0.6 part of 10% FC-430 (a fluorosurfactant) and 74 parts of DESMODUR N-100, had been deposited beforehand was held in an oven at 120° C. for 5 minutes.

The monolayer film was then laminated at 130° C. onto the polyester substrate (therefore giving a PET/PU adhesive/monolayer film structure). The adhesive strength obtained was greater than 40 N/cm. After 8 hours in an oven at 95° C., the adhesion was maintained, and the structure could be easily folded without thereby generating cracks within the fluorinated film. This film also exhibited excellent fire resistance.

### Example 4

### According to the Invention, 1st Form

This example illustrates the preparation of the PVDF-based monolayer film using the technique of blown film coextrusion. A two-layer structure consisting of:
a 15 μm thick layer comprising, by weight, 83% PVDF-3, 15% Sb₂O₃ and 2% of a PEG of 1500 g/mol molecular weight from Clariant; and
a 50 μm thick layer of a LACQTENE 1003FE23 polyethylene (MFI=0.3 g/10 min according to ISO 1133 and density=0.923 according to ISO 1183) sold by Total Petrochemicals,
   was produced in a KIEFEL blown film extruder at a temperature of 245° C. No adhesion was generated between the two layers. The PE layer is the layer L1 previously described as “liner”.

A polyester (PET) substrate, onto which an adhesive of the urethane family, obtained by reacting 100 parts of TONE® 201 with 0.5 parts of a 1% DBTL (dibutyl ter dilaurate) solution in xylol, 60 parts of propylene glycol methyl ether acetate, 0.6 part of 10% FC-430 (a fluorosurfactant) and 74 parts of DESMODUR N-100, had been deposited beforehand was held in an oven at 120° C. for 5 minutes.

The two-layer film was then laminated at 130° C. onto the polyester substrate, the layer in contact with the PU adhesive being that containing the PVDF-3. During and after the lamination phase, a PET/PU adhesive/monolayer PVDF-3-containing film complex was thus obtained, this being protected by the PE layer which could then be simply removed before using the complex.

The adhesive strength obtained between the PET and the PVDF-based film was greater than 40 N/cm. After 8 hours in an oven at 95° C., the adhesion was retained and the structure could be easily folded without thereby generating cracks in the fluorinated film. This film also exhibited excellent fire resistance.

1. A multilayer structure comprising:
a polyvinylidene fluoride (PVDF)—based film F1 bonded to a polyethylene terephthalate (PET) or polyethylene naphthalate (PEN) sheet; or
a PVDF-based film F1 bonded to a PET or PEN sheet which is itself bonded to a PVDF-based film F2,
the film F1 and/or F2 comprising (in the order starting from the PET or PEN sheet):
optionally, a layer of composition B comprising 5 to 40 parts of at least one PVDF, 60 to 95 parts of at least one PMMA and 0 to 5 parts of at least one UV absorber, the total making 100 parts;
a layer of composition A, comprising 50 to 100 parts of at least one PVDF, 0 to 50 parts of at least one polymethyl methacrylate (PMMA), 0 to 30 parts of at least one mineral filler and 0 to 3 parts of at least one dispersing agent, the total making 100 parts; and
optionally, a layer of composition C comprising 80 to 100 parts of at least one PVDF, 0 to 20 parts of at least one PMMA, 0 to 30 parts of at least one mineral filler and 0 to 3 parts of at least one dispersing agent, the total making 100 parts,
wherein an adhesive layer is placed between the PET or PEN sheet and the film F1 and/or F2;
wherein said adhesive layer is optional if the layer of composition B is present and containing no polyolefin functionalized by an unsaturated carboxylic acid or anhydride, or else a homopolymer or copolymer comprising, as monomer(s), acrylic acid, alkyl acrylates and acrylates, which is optionally modified by an unsaturated acid or anhydride; and
wherein compositions A and/or B contain no acrylic elastomer nor any core-shell particle.

2. The structure as claimed in claim 1, wherein the PVDF is a flexible PVDF comprising, by weight, 5 to 20%, of a fluorinated comonomer per 80 to 95%, of VDF.

3. The structure as claimed in claim 1, wherein the PVDF of composition A and/or composition B comprises, by weight, 5 to 20% of a fluorinated comonomer per 80 to 95% of VDF.

4. The structure as claimed in claim 1, wherein the PVDF of composition C is a PVDF homopolymer.

5. The structure as claimed in claim 1, wherein the PVDF is a copolymer with a fluorinated comonomer, and wherein the fluorinated comonomer is selected from the group consisting of vinyl fluoride; trifluoroethylene (VF3); chlorotrifluoroethylene (CTFE); 1,2-difluoroethylene; tetrafluoroethylene (TFE); hexafluoropropylene (HFP); perfluoro(alkyl vinyl)ethers, perfluoro(methyl vinyl)ether (PMVE), perfluoro(ethyl vinyl)ether (PEVE), perfluoro(propyl vinyl)ether (PPVE); perfluoro(1,3-dioxole); and perfluoro(2,2-dimethyl-1,3-dioxole) (PDD).

6. The structure as claimed in claim 1, wherein the PMMA comprises, by weight, 0 to 20% of a C₁-C₈ alkyl(meth)acrylate.

7. The structure as claimed in claim 1, wherein the optional adhesive layer consists of a urethane, epoxy, acrylic or polyester adhesive.

8. The structure as claimed in claim 1, wherein the UV absorber is of the benzotriazole, benzophenone, benzylidene malonate or quinazoline type.

9. The structure as claimed in claim 1, wherein the dispersing agent is a polyethylene glycol.

10. The structure as claimed in claim 9, wherein the polyalkylene glycol has a number-average molecular weight of between 1000 and 10 000 g/mol.

11. The structure as claimed in claim 1, wherein the mineral filler is selected from the group consisting of a metal oxide titanium dioxide (TiO₂), silica, quartz, alumina, a carbonate, calcium carbonate, talc, mica, dolomite (CaCO₃.MgCO₃), montmorillonite (aluminosilicate), BaSO₄, ZrSiO₄, Fe₃O₄, antimony oxide (Sb₂O₃, Sb₂O₅), Al(OH)₃, Mg(OH)₂, huntite (3MgCO₃.CaCO₃), hydromagnesite (3MgCO₃.Mg(OH)₂.3H₂O), carbon black and carbon nanotubes.

12. The structure as claimed in claim 13, wherein in a photovoltaic module, the PVDF-based film being placed on the module via the PVDF-based film F1.

13. A substrate/PVDF-based film structure, comprising:
a) a substrate selected from the group consisting of:
a photovoltaic module;
a technical textile; or
a metal, and
b) a PVDF-based film comprising (in the order starting from the substrate):
optionally, a layer of composition B comprising 5 to 40 parts of at least one PVDF, 60 to 95 parts of at least one PMMA and 0 to 5 parts of at least one UV absorber, the total making 100 parts;
a layer of composition A, comprising 50 to 100 parts of at least one PVDF, 0 to 50 parts of at least one PMMA, 0 to 30 parts of at least one mineral filler and 0 to 3 parts of at least one dispersing agent, the total making 100 parts; and
optionally, a layer of composition C comprising 80 to 100 parts of at least one PVDF, 0 to 20 parts of at least one PMMA, 0 to 30 parts of at least one mineral filler and 0 to 3 parts of at least one dispersing agent, the total making 100 parts, wherein an adhesive layer is placed between the substrate and the PVDF-based film, this adhesive layer being optional if the layer of composition B is present.

14. The structure as claimed in claim 13, wherein composition A comprises 50 to 70 parts of at least one PVDF, 10 to 40 parts of at least one PMMA and 10 to 25 parts of at least one mineral filler, the total making 100 parts.

15. (canceled)

16. The structure as claimed in claim 13, wherein the technical textile is woven or non-woven.

17. The structure as claimed in claim 13, wherein the technical textile is made of PVC, of polyester or of polyamide, a glass fabric, a glass mat, an aramid or a KEVLAR fabric.

18. (canceled)

19. (canceled)

20. A process for manufacturing a PVDF-based film as claimed in claim 1, comprising coextruding:
a) the various layers of the PVDF-based film (of compositions A, B, C);
b) a layer L1 of a polyolefin adjacent the layer of composition A or the layer of composition C; and
c) optionally, another layer L2 of a polyolefin adjacent the combination of the layers extruded at a) and b), on the side opposite the layer extruded at b),
and, cooling the coextrudate, and recovering the PVDF-based film by separating it from the polyolefin layer(s).

21. The structure as claimed in claim 2, wherein the PVDF comprising, by weight, 7 to 13%, of a fluorinated comonomer 87 to 93%, of VDF.

22. The structure as claimed in claim 6, wherein said C₁-C₈ alkyl(meth)acrylate comprises methyl acrylate and/or ethyl acrylate.
